(19) United States
(12) Patent Application Publication
(10) Pub. No.: US 2026/0366815 A1
(43) Pub. Date: Nov. 19, 2026

(54) METHOD FOR ASPIRATING EXHAUST GASES DURING THE LOADING OF HOT ASPHALT FROM AN ASPHALT PRODUCTION

(71) Applicant: Ammann Schweiz AG, Langenthal (CH)

(72) Inventor: Philipp Stampfli, Solothurn (CH)

(21) Appl. No.: 19/475,571

(22) PCT Filed: Apr. 19, 2023
(86) PCT No.: PCT/EP2023/060122

§ 371 Date: Oct. 15, 2025

(51) Int. Cl. F26B 25/00; B01D 53/26; B65G 67/04; B65G 69/18; F23G 7/06; F26B 21/25

(52) U.S. Cl. CPC F26B 25/007; B01D 53/26; B65G 67/04; B65G 69/186; F23G 7/061; F26B 21/25; B01D 2257/702; B01D 2257/80; F23G 2206/201

(57) ABSTRACT

The invention relates to a method for aspirating exhaust gases during the loading of hot asphalt from an asphalt production plant (1) onto a transport vehicle (2). The hot asphalt, which is ready for installation, is stored in asphalt storage silos and loaded onto the transport vehicle (2) located below. The asphalt storage silos are arranged inside a hood (4) that is closed at the top and open at the bottom, such that there is a gap (12), which essentially surrounds these silos and connects the open lower end (U) of the hood (4) to the closed upper end (O) of the hood (4), between the inner boundaries of the hood (4) and the asphalt storage silos. During the loading of the hot asphalt onto the transport vehicle (2), a negative pressure is generated at the upper end (o) of the hood (4) so that exhaust gases emanating from the hot asphalt in the loading area and any exhaust gases emanating from the asphalt storage silos are transported to the upper end of the hood (4) and extracted there. The invention makes it possible to aspirate virtually all exhaust gases produced during the supply and loading of hot asphalt in concentrated form and to dispose of them in a targeted manner. Another advantage is that the contaminated air volumes aspirated in this process can be reduced to a fraction of the contaminated air volumes resulting from the state of the art, which makes their post-treatment/disposal significantly cheaper.

### CROSS-REFERENCE TO RELATED APPLICATIONS

This application is a National Stage application of International Patent Application No. PCT/EP2023/060122, filed on Apr. 19, 2023, which is hereby incorporated by reference in its entirety.

### TECHNICAL FIELD

The invention relates to a method for aspirating exhaust gases during the loading of hot asphalt from an asphalt production plant onto a transport vehicle, as well as an asphalt production plant for carrying out the method according to the preambles of the independent patent claims.

### BACKGROUND

When hot asphalt is loaded from an asphalt production plant onto a transport vehicle, foul-smelling exhaust gases and pollutants (blue smoke) are released, which often leads to complaints from authorities and people living in the vicinity of such plants.

In order to reduce these emissions, some of the exhaust gases released are now aspirated from known plants by means of aspiration pipes located in the loading zone. Apart from the fact that huge amounts of air have to be aspirated from the loading zone and then disposed of/treated, this requires a great deal of energy and is unsatisfactory in the end because a large proportion of the exhaust gases still escape into the environment.

### SUMMARY

The objective here is to provide technical solutions that do not have the aforementioned disadvantages of the prior art or at least partially avoid them.

This objective is reached by the subject matter of the independent patent claims.

According to these, a first aspect of the invention relates to a method for aspirating exhaust gases when loading hot asphalt from an asphalt production plant (often referred to as an “asphalt mixing plant”) onto a transport vehicle.

The hot asphalt ready for loading is stored in one or more asphalt storage silos (often referred to as “mixing silos”) and loaded onto a transport vehicle located below by means of gravity conveyance.

The asphalt storage silo(s) are arranged inside a hood that is closed at the top and open at the bottom, such that there is a gap or gaps between the inner boundaries of the hood and the asphalt storage silos, which connects or connect the open lower end of the hood to the closed upper end of the hood. Supporting webs and/or air baffles extending substantially in the vertical direction may be present in this gap or these gaps.

In a preferred embodiment of the method, the gap is a gap extending substantially around the asphalt supply silos.

At least during the loading of the hot asphalt onto the transport vehicle, a negative pressure is generated at the upper end of the hood so that exhaust gases emanating from the hot asphalt in the loading area and any exhaust gases emanating from the asphalt storage silos, possibly assisted by their thermal buoyancy, are transported to the upper end of the hood and extracted there. This creates a flow around the asphalt storage silos, which removes the exhaust gases from the loading zone and any exhaust gases emitted from the silos.

The invention makes it possible to aspirate virtually all exhaust gases produced during the supply and loading of hot asphalt in concentrated form and to dispose of them in a targeted manner. Another advantage is that the contaminated air volumes extracted in this process can be reduced to a fraction of the contaminated air volumes resulting from the state of the art, which makes their post-treatment/disposal significantly cheaper. For example, it is possible to feed the entire amount of extracted air to a burner in a drying drum of the asphalt production plant for thermal post-treatment.

In a preferred embodiment of the method, the hot asphalt is fed into the asphalt supply silo(s) using a traveling bucket. The hot asphalt is transferred from the traveling bucket to the at least one asphalt supply silo also inside the hood.

If the traveling bucket is loaded with hot asphalt from an asphalt mixer, which is common practice, it is preferable that the transfer of the hot asphalt from the asphalt mixer to the traveling bucket also takes place inside the hood.

This makes it possible to extract the exhaust gases that accumulate in the transfer zones from the asphalt mixer to the traveling bucket and from the traveling bucket to the asphalt storage silo(s) completely and in concentrated form and to dispose of them.

It is advantageous to use the aspirated exhaust gases, either in whole or in part, as combustion air for a burner in the asphalt production plant to heat the material to form the hot asphalt to be produced, for example as combustion air for a burner in a drying drum to heat white mineral material. In this way, treatment/disposal by means of thermal post-treatment can be achieved with little technical effort.

Before being used as combustion air, the aspirated exhaust gases are treated to separate moisture and hydrocarbons and/or filtered to separate dust particles and finest droplets.

A second aspect of the invention relates to an asphalt production plant (asphalt mixing plant) for carrying out the process according to the first aspect of the invention.

The plant comprises one or more asphalt supply silos (mixing silos) for supplying hot asphalt ready for installation for loading onto a transport vehicle.

The asphalt supply silo or silos are arranged inside a hood that is closed at the top and open at the bottom, such that there is a gap or gaps between the inner boundaries of the hood and the asphalt supply silos, which connect the open lower end of the hood to the closed upper end of the hood. Supporting webs and/or air baffles extending substantially in the vertical direction may be present in this gap or these gaps.

In a preferred embodiment of the plant, the gap is a gap extending substantially around the asphalt supply silos.

Furthermore, the asphalt production plant according to the invention comprises an aspiration system by means of which, at least during the loading of the hot asphalt onto the transport vehicle, a negative pressure can be generated at the upper end of the hood so that exhaust gases emanating from the hot asphalt in the loading area and any exhaust gases emanating from the asphalt storage silos, possibly aided by their thermal buoyancy, can be transported to the upper end of the hood and extracted there. This creates a flow around the asphalt storage silos, by means of which the exhaust gases from the loading zone and any exhaust gases emitted from the silos are removed.

Advantageously, the hood widens at its lower end in a funnel shape so that exhaust gases rising in the area around the actual loading zone can also flow into the hood.

Preferably, the system comprises a traveling bucket with which the asphalt storage silo(s) can be fed with hot asphalt. The system is designed in such a way that the hot asphalt can be transferred from the traveling bucket to the respective asphalt storage silo inside the hood. This is advantageously achieved by arranging the traveling bucket in the hood so that it can only be moved within the hood.

It is further preferred that the system comprises an asphalt mixer with which the traveling bucket can be loaded with hot asphalt. The system is designed in such a way that the hot asphalt can be transferred from the asphalt mixer to the traveling bucket inside the hood. This is advantageously implemented in such a way that the discharge opening of the asphalt mixer opens into the interior of the hood, while the mixer itself or at least its feeding devices are located outside the hood.

This makes it possible to aspirate the exhaust gases that accumulate in the transfer zones from the asphalt mixer to the bucket and from the bucket to the asphalt storage silo(s) completely and in concentrated form and to dispose of them.

In a further preferred embodiment, the plant comprises a burner for heating material which is used to form the hot asphalt to be produced by the plant. This can be, for example, the burner of a drying drum for heating white mineral material or recycled asphalt material. The plant is designed in such a way that the aspirated exhaust gases can be used in whole or at least in part as combustion air for the burner. In this way, these exhaust gases can be treated/disposed of by means of thermal post-treatment with little technical effort.

The plant advantageously comprises devices with which the extracted exhaust gases can be treated before their use as combustion air for the burner, in order to separate moisture and hydrocarbons and/or dust particles and finest droplets.

### BRIEF DESCRIPTION OF THE DRAWINGS

Further embodiments, advantages, and applications of the invention are apparent from the dependent claims and from the following description based on the figures. It is shown in

FIG. 1 a highly abstracted front view of an asphalt production plant according to the prior art;

FIG. 2 a representation similar to FIG. 1 of an asphalt production plant according to the invention; and

FIG. 3 the plant diagram of the asphalt production plant of FIG. 2.

### DETAILED DESCRIPTION

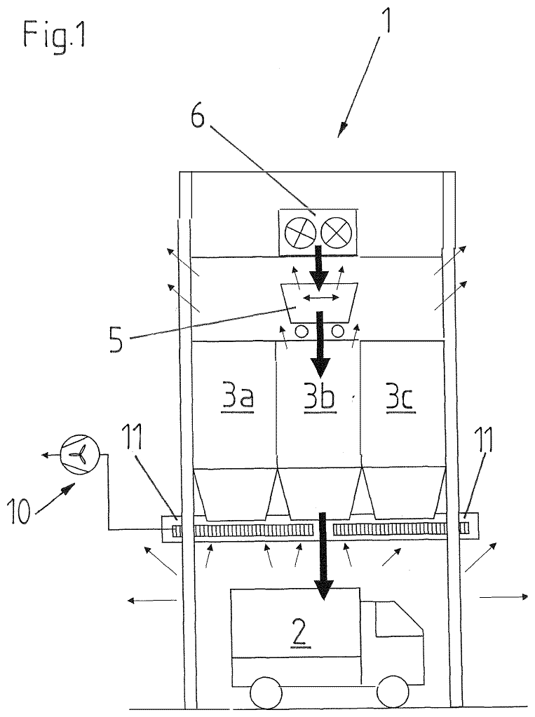

FIG. 1 shows a highly abstracted front view of a state-of-the-art asphalt production plant 1.

As can be seen, the plant 1 comprises several asphalt supply silos 3a, 3b, 3c arranged next to each other for supplying hot asphalt ready for installation for loading onto a transport vehicle 2 arranged below.

A traveling bucket 5 is arranged above the asphalt storage silos 3a, 3b, 3c, which serves to feed hot asphalt into the individual asphalt storage silos 3a, 3b, 3c in batches. The traveling bucket 5 in turn receives the hot asphalt from an asphalt mixer 6 arranged above it. The asphalt material streams from the asphalt mixer 6 into the traveling bucket 5, from the traveling bucket 5 into the asphalt storage silos 3a, 3b, 3c, and from the asphalt storage silos 3a, 3b, 3c onto the transport vehicle 2 are shown with thick arrows. Each time the hot asphalt material is transferred, exhaust gases are released, which are represented by thin arrows.

The exhaust gases released during loading onto the transport vehicle 2 are partially extracted by means of an aspirating device 10 via aspirating pipes 11 arranged in the loading zone. The exhaust gases released during transfer from the asphalt mixer 6 to the bucket and from the bucket 5 to the asphalt storage silos 3a, 3b, 3c are released into the environment, as is the non-extracted portion of the exhaust gases released during loading onto the transport vehicle 2.

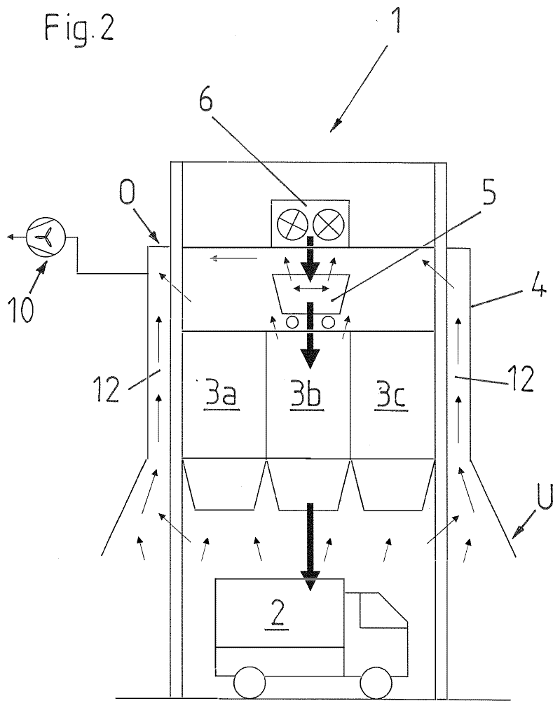

FIG. 2 shows, in a highly abstract form, a front view of an asphalt production plant 1 according to the invention, which has an identical structure to the plant shown in FIG. 1 with regard to the main components of the plant (asphalt supply silos 3a, 3b, 3c, traveling bucket 5, and asphalt mixer 6). Instead of the aspirating pipes 11 in the loading zone, however, the plant 1 according to the invention has a hood 4 that is closed at the top and open at the bottom, inside which the asphalt supply silos 3a, 3b, 3c and the traveling bucket 5 are arranged. The asphalt mixer 6 is located outside the hood 4 and its discharge opening opens from above into the space formed by the hood 4. Between the inner boundaries of the hood 4 and the asphalt supply silos 3a, 3b, 3c, there is a gap 12 that essentially surrounds the asphalt supply silos and connects the open lower end of the hood 4 with the closed upper end of the hood 4. Supporting webs and/or air baffles extending substantially in the vertical direction may be present in this gap 12.

At its lower end U, the hood 4 widens in a funnel shape. An aspiration opening is arranged at its upper end O, via which, at least during the loading of the hot asphalt onto the transport vehicle, a negative pressure is generated at the upper end O of the hood 4 by means of the aspirating device 10, so that the exhaust gases emanating from the hot asphalt in the loading area and all other exhaust gases released in the hood 4, additionally supported by their thermal buoyancy, are transported to the upper end O of the hood 4 and aspirated there.

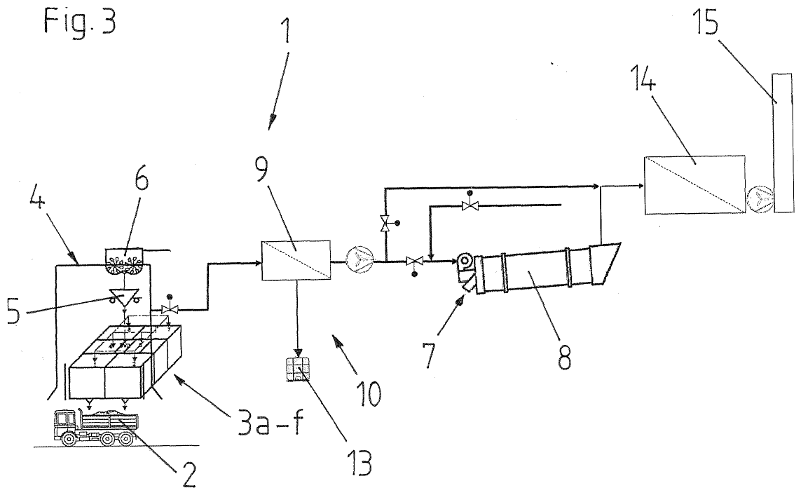

As can be seen in conjunction with FIG. 3, which shows the system diagram of the asphalt production plant according to the invention from FIG. 2, the air aspirated from the hood 4 and contaminated with the exhaust gases is treated in a separation unit 9, whereby moisture and hydrocarbons as well as dust and finest droplets carried therein are separated. These are collected in a tank 13 and sent for disposal. The pre-cleaned exhaust air from hood 4 is then either fed as combustion air to burner 7 of the white mineral drying drum 8 of plant 1 or discharged into the atmosphere via the raw gas filter system 14 of the drying drum 8 and the associated chimney system 15.

As can be seen in FIG. 3, plant 1, located inside hood 4, has a total of six asphalt supply silos 3a-f, which are fed with hot asphalt material via the traveling bucket 5.

While preferred embodiments of the invention are described in the present application, it should be clearly noted that the invention is not limited to these and may also be carried out in other ways within the scope of the following claims.

What is claimed is:

1. A method for aspirating exhaust gases during the loading of hot asphalt from an asphalt production plant onto a transport vehicle, comprising the steps:
a) Providing ready-to-use hot asphalt in at least one asphalt supply silo, which is arranged within an upwardly closed and downwardly open hood in such a way that a gap or multiple gaps, which connects or connect the open lower end of the hood to the closed upper end of the hood, are formed between the inner boundaries of the hood and the at least one asphalt supply silo,
b) Placing a transport vehicle under the at least one asphalt supply silo,
c) loading hot asphalt by means of gravity conveyance from the at least one asphalt supply silo onto the transport vehicle,
wherein, at least during the loading of the hot asphalt onto the transport vehicle, a negative pressure is generated at the upper end of the hood so that exhaust gases emanating from the hot asphalt in the feed area and any exhaust gases emanating from the at least one asphalt supply silo are transported to the upper end of the hood and extracted there.

2. The method according to claim 1, wherein the gap is a gap extending substantially around the at least one asphalt supply silo.

3. The method according to claim 1, wherein the at least one asphalt supply silo is fed with hot asphalt by a traveling bucket, wherein the transfer of the hot asphalt from the traveling bucket to the at least one asphalt supply silo takes place inside the hood.

4. The method according to claim 3, wherein the traveling bucket is loaded with hot asphalt from an asphalt mixer, wherein the transfer of the hot asphalt from the asphalt mixer into the traveling bucket takes place inside the hood.

5. The method according to claim 1, wherein the extracted exhaust gases are at least partially used as combustion air for a burner of the asphalt production plant for heating material to form hot asphalt to be produced, in particular as combustion air for a burner of a drying drum for heating white mineral material or recycled asphalt material.

6. The method according to claim 5, wherein the extracted exhaust gases are treated prior to their use as combustion air for the burner in order to separate moisture and hydrocarbons.

7. The method according to claim 5, wherein the extracted exhaust gases are filtered before being used as combustion air for the burner in order to separate dust particles and/or finest droplets.

8. An asphalt production plant for carrying out the method according to one of the preceding claims, comprising
a) at least one asphalt supply silo for supplying hot asphalt ready for installation for loading onto a transport vehicle, wherein the at least one asphalt supply silo is arranged within a hood that is closed at the top and open at the bottom in such a way that a gap or multiple gaps are formed between the inner boundaries of the hood and the at least one asphalt supply silo, which connects or connect the open lower end of the hood to the closed upper end of the hood, and
b) an extraction system by means of which, at least during the loading of hot asphalt from the at least one asphalt supply silo onto a transport vehicle at the upper end of the hood, so that exhaust gases emanating from the hot asphalt in the loading zone and any exhaust gases emanating from the at least one asphalt supply silo can be transported to the upper end of the hood and extracted there.

9. The plant according to claim 8, wherein the gap is a gap extending substantially around the at least one asphalt supply silo.

10. The plant according to claim 8, wherein the hood widens into a funnel shape at the lower end.

11. The plant according to claim 8, wherein the plant comprises a traveling bucket with which the at least one asphalt supply silo can be fed with hot asphalt, and wherein the plant is adapted in such a way that the transfer of the hot asphalt from the traveling bucket to the at least one asphalt supply silo can take place inside the hood.

12. The plant according to claim 8, wherein the plant comprises an asphalt mixer with which the traveling bucket can be loaded with hot asphalt, and wherein the plant is designed such that the transfer of the hot asphalt from the asphalt mixer into the traveling bucket can take place inside the hood.

13. The plant according to claim 8, wherein the plant comprises a burner for heating material to form hot asphalt to be produced, in particular a burner of a drying drum for heating white mineral material or recycled asphalt material, and wherein the plant is adapted in such a way that the extracted exhaust gases can be used at least partially as combustion air for the burner.

14. The plant according to claim 13, wherein the plant comprises a device for treating the extracted exhaust gases before their use as combustion air for the burner for the purpose of separating moisture and hydrocarbons.

15. The plant according to claim 8, wherein the plant comprises a device for filtering the extracted exhaust gases before their use as combustion air for the burner for the purpose of separating dust particles and/or finest droplets.
